(19) United States
(12) Patent Application Publication
(10) Pub. No.: US 2005/0228547 A1
(43) Pub. Date: Oct. 13, 2005

(54) Interactive media system and method for use with golf carts

(75) Inventors: David R. McDonnell, Laguna Beach, CA (US); Greg T. Morgan, Mission Viejo, CA (US); Craig H. Petrik, San Juan Capistrano, CA (US)

Correspondence Address: Donald E. Stout;Stout, Uxa, Buyan & Mullins, LLP, Suite 300, 4 Venture, Irvine, CA, 92618, US

(73) Assignee: Golf Cart Media, Inc., San Juan Capistrano, CA (US)

(21) Appl. No.: 10/875,352

(22) Filed: Jun. 24, 2004

Related U.S. Application Data
(60) Provisional application No. 60/561,401, filed on Apr. 12, 2004.

(51) Int. Cl. G05D 1/00

(52) U.S. Cl. 701/1

(57) ABSTRACT

A Global Positioning System (GPS) is provided for use by golfers in their golf carts, which supplies useful yardage information to the golfer without the need for frequent manual maintenance by the golf course. Furthermore, the inventive system also comprises a highly effective advertising medium for reaching golfers at the golf course, without being unduly obtrusive. A business method related to providing the GPS system to golf courses benefits those courses by permitting them to obtain the system at no cost, and, in fact, typically at a substantial financial gain, and also permits them to obtain updated and improved golf carts at a substantial discount. Golf courses also benefit because of faster resultant play by golfers on the course, thus permitting them to consider offering more tee times.

This application claims the benefit under 35 U.S.C. 119(e) of the filing date of Provisional U.S. Application Ser. No. 60/561,401, entitled Interactive Media System and Method for Use with Golf Carts, and filed on Apr. 12, 2004, which application is expressly incorporated herein by reference.

### BACKGROUND OF THE INVENTION

The present invention relates to methods and apparatus for providing an advertising-supported interactive media system, particularly for golf course application, designed to reduce costs for golf courses and also to supply useful and interesting information to golfers, in a manner which is maximally effective and minimally intrusive.

Advertisers are constantly looking for new and more effective, cost-efficient methods of introducing their products and services to customers likely to utilize and appreciate them. The golfer demographic is the most widely sought after consumer by advertisers, because of its affluence, yet the only traditional way of reaching this demographic has been through traditional advertising. This advertising has limited reach, and it does not capture the golfer at the golf course.

Golf cart advertising is literally non-existent at present. Occasionally, advertising can be found on the back of scorecards, cart sign holders, and as a component of some Global Positioning System (GPS) systems currently available in the market, for golf course use. Introduction of GPS-equipped golf carts with monitors capable of displaying hole layouts and the yardage to the cup has occurred in very limited scope. Advertising is limited, because it is up to the individual golf courses equipped with such systems to sell and upload the advertising. The average cost of such GPS systems is $200,000 or more per golf course. For this reason, market penetration is currently less than 2% of U.S. golf courses.

Current GPS systems have such limited market penetration for a number of reasons, in addition to extreme cost. One reason is that golf courses have to program yardages each day, depending upon where the holes are located on that day. Often, this re-programming is not done, resulting in a display of inaccurate yardages. Second, current monitor locations are such that golfers often hit their head when entering or exiting the cart. To combat this, one company mounts the screen on the steering column. The reflective glare from the sun makes the screen very difficult to see.

Golfers want to know the yardage to the green. Finding yardage can be time consuming. Stakes, imbedded plates, and sprinkler head yardages assist the golfer with this determination, but the problem is that most golf balls are not hit near these markers, thus requiring golfers to find the marker, pace off the yardage to the ball, and then select a club. This approach obviously substantially slows play.

What is needed, therefore, is a GPS system which provides information useful to the golfer, but requiring a minimum of maintenance (i.e. reprogramming) by the golf course. Since such systems are expensive to install, it would be beneficial if the cost of such systems could be offset, totally or in large extent, by advertisers, who, at the same time, obtain a heretofore unavailable benefit of relatively low-cost and highly effective advertising access to golfers at the golf course.

### SUMMARY OF THE INVENTION

The present invention satisfies the above described objectives, by providing a highly effective GPS system for use by golfers in their golf carts, which supplies useful yardage information to the golfer without the need for frequent manual maintenance by the golf course. Furthermore, the inventive system also comprises a highly effective advertising medium for reaching golfers at the golf course, without being unduly obtrusive. A unique and advantageous method of doing business, also comprising a part of the present invention, benefits golf courses by permitting them to obtain effective GPS systems at no cost (and, in fact, typically at a substantial financial gain), and also permits them to obtain updated and improved golf carts at a substantial discount. Golf courses also benefit because of faster resultant play by golfers on the course, thus permitting them to consider offering more tee times. Golf cart manufacturers benefit by being able to sell or lease such carts at the above described discount. Golfers benefit through lower golfing costs (since golf courses actually experience lower overall costs because of the inventive system and methods), and because they obtain better overall yardage information, faster play, and useful product and service information, concerning products and services which are likely of interest to them.

More particularly, in one aspect of the invention there is provided a golf cart top adapted for attachment to a golf cart, which comprises a raised forward portion, a downwardly sloping portion aft of the raised forward portion, a lower rearward portion, and wireless transmitting and receiving apparatus disposed on the golf cart top, aft of the raised forward portion. Because of this unique configuration, the raised forward portion functions to protect the wireless transmitting and receiving apparatus from overhead obstacles.

Preferably, the golf cart top further comprises a cavity disposed on an underneath surface of the raised forward portion, for receiving and mounting a video monitor, which is preferably mounted at an angle of greater than ten degrees relative to a vertical axis, and more preferably approximately 55 degrees.

In another aspect of the invention, there is provided a golf cart, which comprises a golf cart body, a plurality of posts upstanding from the golf cart body, and a golf cart top mounted on the plurality of posts. The golf cart top comprises a raised forward portion, a downwardly sloping portion aft of the raised forward portion, and a lower rearward portion. Additionally, the golf cart top comprises a wireless transmitting and receiving apparatus disposed thereon, aft of the raised forward portion, so that the raised forward portion functions to protect the wireless transmitting and receiving apparatus from overhead obstacles.

In still another aspect of the present invention, there is provided an interactive media system for a golf course, which comprises a central processing unit (CPU) for downloading executable media files from a remote source, as well as a golf cart, and a microprocessor and memory unit disposed on the golf cart, for receiving an executable media file from the CPU. Additionally, a video monitor is disposed on the golf cart, for displaying output from the executable media file as it is run by the microprocessor and memory unit. Preferably, the executable media files are transmitted to the microprocessor using a wireless transmitting system. The microprocessor in the golf cart is also configured to receive and display additional information on the monitor, which may comprise, for example, real time sports scores or stock market quotations, or any other information which may be of interest to the golfer community. In a particularly preferred embodiment, a GPS transmitter/receiver is disposed on the golf cart, and is adapted to operate cooperatively with the microprocessor to display information on the monitor related to the distance from the golf cart to a desired green. Coordinates of the front, middle, and back of each green are stored in the memory unit in the golf cart, which are employed by the microprocessor and GPS transmitter/receiver disposed on the golf cart to generate the above mentioned information, which comprises the distance from the golf cart at any point in time to the front, middle, and back of a desired green.

In the preferred embodiment, the executable media file comprises a loop which includes advertising spots interspersed with entertainment spots. Additionally, there are preferably a plurality of golf carts similar to the golf cart, each of which is equipped with a microprocessor and memory unit and a video monitor. The executable media files are transmitted to each of the microprocessors on each of the golf carts using a wireless transmitting system.

In still another aspect of the invention, there is disclosed a method of providing an interactive media system for use in golf carts on a golf course, comprising steps of equipping each of a plurality of golf carts with a microprocessor and memory unit and a video display monitor, selling a plurality of advertising spots to one or more purchasers, and preparing an executable file comprising the plurality of advertising spots and downloading the executable file to a CPU at the golf course. Additional steps include transferring the executable file to the microprocessor and memory unit on each of the plurality of golf carts, and running the executable file so that an output thereof is displayed on the video display monitor on each of the plurality of golf carts. Preferably, the executable file is prepared and downloaded to the CPU from a remote location.

In a preferred method, the equipping step comprises providing a golf cart top for each of the plurality of golf carts, wherein the golf cart top is equipped with the microprocessor and memory unit and the video display monitor. The golf cart top is provided to the golf course free of charge, and the advertising spots are interspersed with a plurality of entertainment spots. Moreover, the preferred method comprises a step of displaying additional information of general interest to golfers on the monitor, such as sports scores or stock quotations. A GPS receiver/transmitter is preferably provided on each of the plurality of golf carts, and the additional information may comprise distances from the golf cart to each of the front, middle, and back of a desired green. The additional information is displayed on a banner disposed on a lower or upper portion of a screen on the monitor, or, alternatively, on banners disposed on both lower and upper portions of the screen.

Further steps of the present method are to provide a percentage of all revenue generated from the selling step to the golf course, identifying golfers exposed to advertising displayed on the monitor and providing contact information for those golfers to the advertising purchasers for follow-up, and providing links for the purchasers on the Internet home page of the golf course.

The invention, together with additional features and advantages thereof, may best be understood by reference to the following description taken in conjunction with the accompanying illustrative drawing.

### BRIEF DESCRIPTION OF THE DRAWINGS

FIG. 1 is a top view of the top of a golf cart, constructed in accordance with the principles of the present invention;

FIG. 2 is a perspective view of the golf cart top illustrated in FIG. 1;

FIG. 3 is a left side view of the golf cart top illustrated in FIGS. 1 and 2;

FIG. 4 is a forward looking view, from the rear, of the golf cart top illustrated in FIGS. 1-3;

FIG. 5 is a bottom view of the golf cart top illustrated in FIGS. 1-4;

FIG. 6 is a perspective view, from the side, of a golf cart equipped with an interactive media system in accordance with the principles of the present invention;

FIG. 7 is a schematic view of the interactive media system configured in accordance with the principles of the present invention; and

FIG. 8 is a schematic representation of a video monitor, showing a graphical presentation scheme arranged in accordance with the principles of the present invention.

### DESCRIPTION OF THE PREFERRED EMBODIMENT

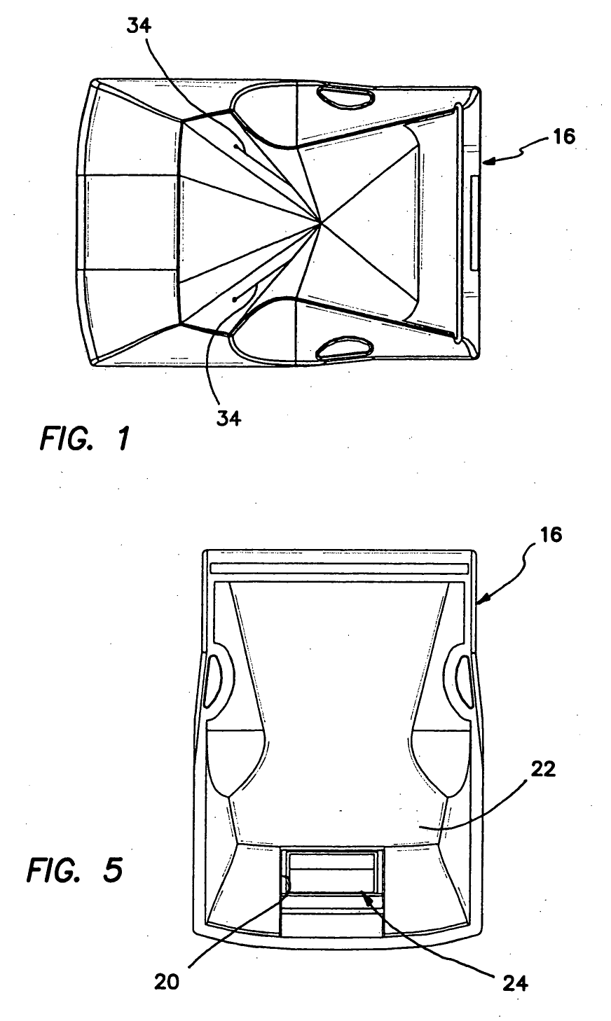

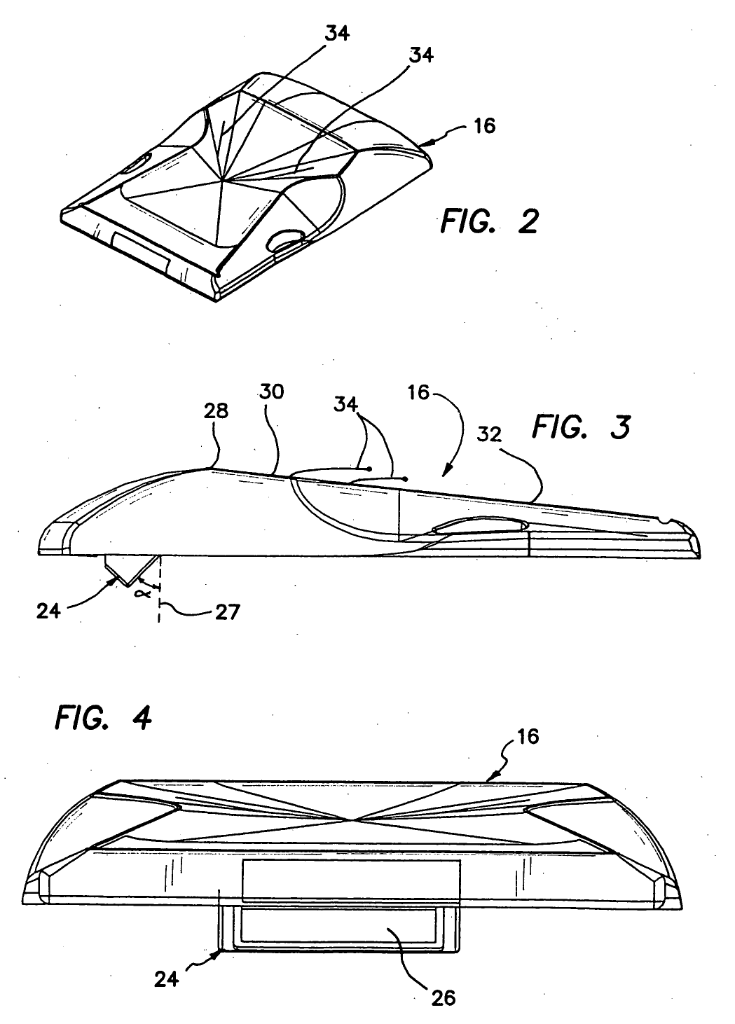

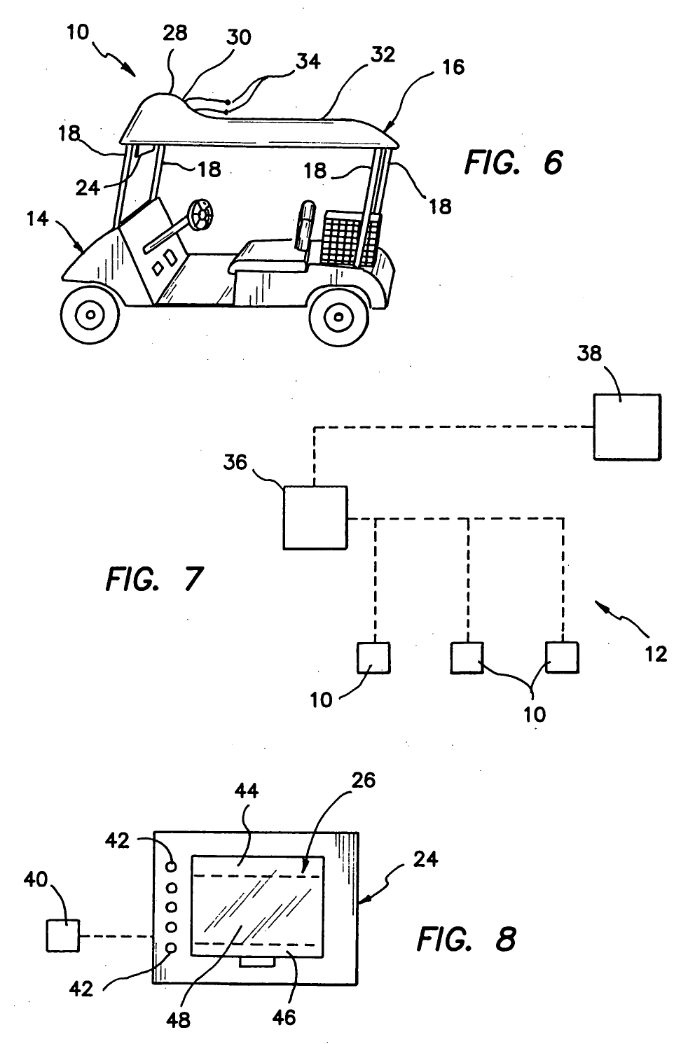

Referring now to FIGS. 1-8, there is shown a golf cart 10 (FIG. 6) which is equipped with an interactive media system 12 (FIG. 7), configured in accordance with the principles of the present invention. The golf cart 10 comprises a body 14 of conventional construction and a top 16 which is disposed above the body 14 on four conventional posts 18. The golf cart top 16 may be of generally conventional construction, typically of molded plastic, such as rotationally molded high-density polyethylene with ultra-violet (UV) resistant properties, except for some unique features which will be described below. It is designed to be utilized in combination with known golf carts, including, for example, those manufactured by EZ Go, Yamaha, and Club Car.

The golf cart top 16 comprises a monitor cavity 20 (FIG. 5) preferably molded into a lower surface 22 of the top 16 at a forward end thereof, within which is disposed a video monitor unit 24. Advantageously, the disposition of the monitor 24 up within the cavity 20 minimizes any obstruction of the view ahead of the cart 10 from within the cart. The monitor 24 is disposed with its video screen 26 facing rearwardly, so that occupants of the cart may readily view the screen 26. The top 16 is designed to be adaptable for use with any commonly available golf cart. The video screen 26, in a preferred embodiment, has a screen size of 10.4 inches, although any suitable screen size may be employed. Also, the preferred monitor is a color LCD (Liquid Crystal Display) model, although, again, any suitable monitor may be employed. Relative to a vertical axis 27 (FIG. 3), the monitor 24 is preferably tilted at an angle α of greater than 10 degrees and preferably about 55 degrees, in order to reduce its profile. The combination of the monitor's recessed position in the cavity, and the screen tilt functions to advantageously minimize screen glare, by minimizing incident light on the screen 26.

The golf cart top 16 also preferably comprises a raised forward portion 28 (FIG. 3) which slopes downwardly through a sloped portion 30 toward a lower rearward portion 32. Wireless transmitting and receiving apparatus, such as one or more antennas 34, extends rearwardly from the sloped portion 30. Advantageously, the raised forward portion 28 protects the antenna from damage due to overhead trees, low overpasses, and the like. The purpose of the antennas 34, which may alternatively be internally mounted, in any suitable manner, will be discussed in greater detail hereinbelow.

Now with particular reference to FIG. 7, there is shown a schematic representation of the interactive media system 12 of the present invention. Typically, a plurality of golf carts 10 are parked in a golf cart barn or garage overnight or otherwise when the golf course is closed. A computer 36 or other suitable device is disposed therein as well, for downloading executable content from a remote server or source 38 over the Internet or via satellite, and then transferring that content to each of the golf carts 10.

In FIG. 8, the video monitor unit 24 is illustrated schematically. This unit includes a microprocessor and memory unit 40 which also includes a Global Positioning System (GPS) transmitter/receiver. The microprocessor 40 is programmed to receive an executable media file from the computer 36, which is displayable on the video screen 26. Additionally, the microprocessor utilizes the GPS transmitter/receiver to calculate and display on the video screen 26 the yardages from the cart's location at any given point in time to the green of the current hole. In particular, the coordinates of the front, middle, and back of each green are pre-programmed into a look-up table stored in the memory 40. Then, as the golfer drives the cart about the golf course, he or she may at any time view the GPS feature, which is conventional except as described herein, to determine the location from the cart's position at that instant to the front, middle, and back of a selected green. The GPS yardages are set-up to automatically display on a continuous basis. This unique approach, whereby yardages are available to each of the front, middle, and back of the green, is more useful than known prior art systems, wherein yardage to the pin is generally available. The reason for this is, first, that non-expert golfers often prefer to know the distance to safely place the ball in the middle of the green, rather than the distance to the pin, particularly if the hole placement is near a hazard or the edge of the green. Second, since golf courses frequently move the holes on each green, the GPS systems in conventional systems must be re-programmed to include the coordinates for the new pin placement each time such changes are made. However, with the present inventive system, such re-programming is avoided.

Another particularly advantageous feature of the present invention is a unique advertising approach which lends itself to easy operation, while effectively reaching the golfing community. As mentioned above, an executable loop of advertising spots is downloaded periodically, preferably nightly, from the remote server 38 to the computer 36 (FIG. 4). In one preferred embodiment, the loop comprises approximately 55 separate advertising spots, each of which is nine (9) seconds in length. Of course, it is within the scope of the invention to change both the length of each spot and the total number of spots to any desired value, although the foregoing specifications have been found to be particularly effective, since 9 second spots are about the right length for obtaining maximum attention from golfers, and the number of spots described above permits a golfer to view each spot as many as twenty four or so times during an eighteen hole round. Golf courses which agree to host the inventive system may be allocated a certain number of advertising spots for their own advertisements, such as for upcoming tournaments, greens fee specials, or merchandise specials in the pro shop.

An additional feature of the preferred embodiment is the interspersing of 50 or so partitioned “entertainment” spots among the 55 or so advertising spots. The purpose of these “entertainment” spots, which may also each comprise about 9 seconds in length, is to maintain the golfers' attention to the monitor by breaking up the advertising spots with interesting facts, trivia, golf instruction tips, and the like.

The executable files may comprise still (JPG) images, animation, MPEG images, or any other known media. The monitor 24 can be turned off by the golfer and by golf course personnel, if desired. For example, such systems are often not permitted during tournament play, and are turned off during such events. Additionally, if a particular cart is to be stored for a considerable period of time, the system should be turned off. The source of power for the system is the golf cart battery, and a disable switch is wired directly to the battery to permit the system to be shut off. The display is preferably in 32 bit color or higher, with high resolution.

As explained above, the executable files are transferred from the computer 36 to the memory 40 in each golf cart 10 periodically. Typically, this transfer occurs weekly, during the night, while the carts are all parked in close proximity to the computer 36 in the cart barn, and are being electrically recharged. The preferred mode of transfer, at present, is via wireless technology (such as Wi-Fi), transmitting the data to the memory 40 on the cart 10 via the antennas 34 disposed on each cart. Then, when the carts are started in the morning, and the onboard computer or memory 40 is turned on, the new executable file is installed from the memory. It should be noted that the present invention is not technology-based, meaning that all of the technology is well known to those skilled in the art, and readily available. Any suitable known technology which is capable of performing the above described functions is fine. What is important, and unique, about the present invention is the manner, as described herein, in which the conventional technology has been assembled and utilized to perform the unique described functions.

The actual advertising content is designed by each client, in accordance with parameters supplied by the system manager, and is uploaded to the remote server 38 by the client. The system permits clients to update their ads weekly, and more often, for an additional fee, if desired. A preferred business method is to charge each client a fixed price per month, per advertising spot, per golf course. Included in this price might be a predetermined number of free advertising updates (i.e. weekly), with additional fees being charged for updates beyond this predetermined number in a given month.

Another advantageous feature of the present business method is to provide to each advertiser, either as an included feature for the fixed monthly fee or as an option for an additional fee, a golfer database for the golf course at issue, which can be utilized by the advertiser for follow-up direct marketing activities. This database is emailed to the advertiser so that the advertiser can, for example, generate a follow-up mailing or e-mailing which might reference a spot the golfer saw or potentially saw during a recent round, and offer an additional incentive (i.e. a free gift for an automobile test drive) if the golfer visits the advertiser's place of business. The golfer can be asked to volunteer to release his/her address or email address for this service, in order to avoid potential legal concerns, in exchange for a reduced greens fee or other suitable incentive.

Additionally, the home page of the golf course preferably includes links to the advertisers which are participating in the described program, to further coordinate the advertiser's marketing efforts.

The present inventive system also is configured to incorporate, if a golf course desires, a clubhouse restaurant interface module for permitting golfers to pre-order food and drinks prior to reaching the clubhouse at the turn between the 9^{th} and 10^{th} holes. This interactive feature comprises an interactive menu screen which pops up when a golf cart reaches a predetermined location, such as the 9^{th} hole tee box, triggered by a wireless transmitter located near this predetermined location. Point-of-sale software completes the order, the order is sent to the restaurant via antenna, and the transaction is processed through the POS software. Thus, by the time the golfer reaches the restaurant, the food is ready for pick-up. The system also includes a capability for the golf course to track precisely the location of all equipped golf carts.

Referring now to FIG. 5, in particular, an advantageous feature of the present invention is the unique video screen layout, which enhances the golfer's attention to the video advertising spots. More particularly, the monitor 24 includes a predetermined number of control knobs 42, for various monitor control functions, such as power, brightness, contrast, auxiliary functions (such as ordering food), golf hole selection, and the like. The video screen 26 is arranged so that an upper banner 44 and a lower banner 46 each display information of interest to the golfer, such as the above described yardage information generated by the onboard GPS system. In a preferred embodiment, these banners 44, 46 are displayed in eye-catching colors, such as red, white, and blue, to attract the golfers' attention. For example, yardage to the front of the green may be displayed in red, to the middle of the green in white, and to the back of the green in blue. Above the lower banner 46 is the main display portion 48, on which the above described advertising and “entertainment” spots are continuously displayed in a loop format. Advantageously, the golfers' eyes are drawn toward the main display portion 48, thus viewing the advertising content. This interactive approach maximizes the golfers' exposure to the advertising content.

The upper banner 44 may display additional information of interest to the golfer. For example, this banner might comprise a scroll, providing updated sports scores or the stock market transmitted by satellite, since such services are now readily available, and might also display the current time and date, or the like.

Of course, alternatively, only one banner might be utilized, and any type of content may be displayed on either banner, as desired. Preferably, the monitor 24 descends beneath the top 16 by a distance just sufficient to permit a golfer to view the lower banner 44, which displays the above described GPS data, from a location outside of the cart 10.

The method for operating the business of providing the inventive system 12 to golf courses is unique and advantageous as well. In a preferred approach, the media system owner/operator approaches a golf course with an offer to install the system, including new golf cart tops, wireless equipment, microprocessors, video equipment, computer, and other necessary components, at no charge to the golf course. In addition, the golf course is offered a percentage of all generated advertising revenue, on a monthly basis. In a preferred method, that percentage is 10%. Of course, the percentage, and the base cost to the golf course can vary, although the basic concept is to provide the system to the course on a basis that it is difficult to refuse, because it is a net revenue generator for the course. Then, as mentioned above, advertisers are charged a flat monthly cost for each spot they purchase. In one preferred embodiment, that cost is $1,200, although, of course, that fee can vary according to market conditions, and the type of media (i.e. JPG, animation, MPEG).

The apparatus and method of the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1-19. (canceled)

20. A method of providing an interactive media system for use in golf carts on a golf course, comprising:
equipping each of a plurality of golf carts with a microprocessor and memory unit and a video display monitor;
providing a plurality of advertising spots to one or more purchasers,
preparing an executable file comprising said plurality of advertising spots and downloading said executable file to a CPU at said golf course;
transferring said executable file to the microprocessor and memory unit on each of said plurality of golf carts; and
running said executable file so that an output thereof is displayed on the video display monitor on each of said plurality of golf carts.

21. The method as recited in claim 20, wherein said equipping step comprises providing a golf cart top for each of said plurality of golf carts, said golf cart top being equipped with said microprocessor and memory unit and said video display monitor.

22. The method as recited in claim 21, wherein said golf cart top is provided to said golf course free of charge.

23. The method as recited in claim 20, wherein said advertising spots are interspersed with a plurality of entertainment spots.

24. The method as recited in claim 20, and further comprising a step of displaying additional information of general interest to golfers on said monitor.

25. The method as recited in claim 24, wherein said additional information comprises sports scores or stock quotations.

26. The method as recited in claim 24, and further comprising a step of providing a GPS receiver/transmitter on each of said plurality of golf carts, and said additional information comprises distances from the golf cart to various locations on a desired green.

27. The method as recited in claim 26, wherein said additional information comprises distances to each of the front, middle, and back of the desired green.

28. The method as recited in claim 24, wherein said additional information is displayed on a banner disposed on a lower or upper portion of a screen on the monitor.

29. The method as recited in claim 28, wherein different elements of said additional information are displayed on banners disposed on both lower and upper portions of said screen.

30. The method as recited in claim 20, and comprising a further step of providing a percentage of all revenue generated from the providing step to the golf course.

31. The method as recited in claim 20, and further comprising a step of identifying golfers exposed to advertising displayed on said monitor and providing contact information for said golfers to the advertising purchasers for follow-up.

32. The method as recited in claim 20, and further comprising a step of providing links for the purchasers on the Internet home page of the golf course.

33. The method as recited in claim 20, wherein said executable file is prepared and downloaded to said CPU from a remote location.

34. A method of providing an interactive media system for use in golf carts on a golf course, comprising:
equipping a golf cart with a microprocessor and memory unit;
equipping said golf cart with a golf cart top having a cavity disposed on an underneath surface thereof;
mounting a video display monitor within said cavity; and
equipping said golf cart top with a wireless transmitting and receiving apparatus.

35. The method as recited in claim 34, wherein said wireless transmitting and receiving apparatus is disposed within said golf cart top.

36. A method of providing an interactive media system for use in golf carts on a golf course, comprising:
equipping a golf cart with a video display monitor which is connected to a microprocessor and a memory unit;
providing a GPS receiver/transmitter on said golf cart;
providing a database in said memory unit; and
storing coordinates in said database for a position on the front of, in the middle of, and at the back of each green on said golf course.

37. The method as recited in claim 36, and further comprising a step of accessing said database and using said GPS receiver/transmitter to calculate a distance from said golf cart to each of the stored positions on one of said greens.

38. The method as recited in claim 37, wherein said distance is displayed on said video display monitor, and is continuously refreshed.

39. The method as recited in claim 36, and further comprising a step of using said GPS receiver/transmitter to determine a precise location of the golf cart from a remote location.

40. The method as recited in claim 36, and further comprising:
providing a plurality of advertising spots to one or more purchasers;
preparing an executable file comprising said plurality of advertising spots and downloading said executable file to a CPU at said golf course,
transferring said executable file to said microprocessor and memory unit; and
running said executable file so that an output thereof is displayed on the video display monitor on said golf cart.

41. The method as recited in claim 36, wherein said equipping step further comprises providing a golf cart top for said golf cart, said golf cart top being equipped with said microprocessor and memory unit and said video display monitor.

42. The method as recited in claim 41, wherein said golf car top is provided to said golf course free of charge.

43. The method as recited in claim 40, wherein said advertising spots are interspersed with a plurality of entertainment spots.

44. The method as recited in claim 40, and further comprising a step of displaying additional information of general interest to golfers on said monitor.

45. The method as recited in claim 44, wherein said additional information comprises sports scores or stock quotations.

46. The method as recited in claim 44, wherein said additional information is displayed on a banner disposed on a lower or upper portion of a screen on the monitor.

47. The method as recited in claim 46, wherein different elements of said additional information are displayed on banners disposed on both lower and upper portions of said screen.

48. The method as recited in claim 40, and comprising a further step of providing a percentage of all revenue generated from the providing step to the golf course.

49. The method as recited in claim 40, and further comprising a step of identifying golfers exposed to advertising displayed on said monitor and providing contact information for said golfers to the advertising purchasers for follow-up.

50. The method as recited in claim 40, and further comprising a step of providing links for the purchasers on the Internet home page of the golf course.

51. The method as recited in claim 40, wherein said executable file is prepared and downloaded to said CPU from a remote location.
